(19) United States
(12) Patent Application Publication
(10) Pub. No.: US 2005/0166368 A1
(43) Pub. Date: Aug. 4, 2005

(54) Process for the recovery of selected salts

(75) Inventor: Asher Vitner, Jerusalem (IL)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(73) Assignee: ASHER VITNER LTD.

(21) Appl. No.: 11/030,711

(22) Filed: Jan. 4, 2005

(30) Foreign Application Priority Data
Jan. 15, 2004 (IL) 159,881

(51) Int. Cl. F24J 2/42

(52) U.S. Cl. 23/295 S

(57) ABSTRACT

The invention provides a process for the separation and recovery of at least one selected salt from a mixture of salts containing at least one salt, the solubility of which increases with increase in temperature, comprising providing a pond having a dark bottom surface and a plurality of stratified salt solution layers wherein the solution closest to the bottom contains a salt concentration higher than that in the upper layers, the solution closest to the bottom is hotter than those in the upper layers and at least some of the layers are saturated with at least one salt; introducing a feed solution containing at least one salt, the solubility of which increases with increase in temperature into the pond thereby resulting in an increased ratio of the at least one salt in the bottom layer; withdrawing a solution from the bottom zone; and withdrawing a solution from the upper zone.

The present invention relates to the recovery of at least one selected salt present in a mixture with other salts to obtain a product enriched with said salt. More particularly, the present invention relates to the separation of salts, the solubility of which increase with increase in temperature from other solutes, the solubility of which are less dependent on temperature.

It is well known to evaporate brines to effect the deposition of a particular salt species. The residual brine formed as a result of the evaporation is concentrated in respect to soluble salts initially contained in the brine at less than saturation concentration and is itself a potential source of valuable minerals. Such brines may be used for the production of such salts. Among the salts produced in this way, NaCl is the most commonly used.

It is well known to evaporate brines containing a salt, the solubility of which increases with increase in temperature at high temperature and to induce its precipitation by cooling the solution and inducing precipitation of those salts. The residual brine formed as a result of cooling is concentrated in respect to soluble solutes the solubility of which is not dependent or is less dependent on temperature, initially contained in the brine at less than saturation concentration. Among the salts produced in this way there can be mentioned KCl, carnallite, MgCl₂, MgSO₄, K₂SO₄ and many other salts.

It is well known to combine evaporation and heating/cooling cycles with or without dilution in order to split brines containing a mixture of salts, the solubility of which increases with increase in temperature at high temperature into streams enriched with those salts. Among the mixture of salts produced in this way there can be mention the process of Kanite treatment for the production of K₂SO₄ and KCl, the process of splitting carnallite into KCl and MgCl₂ and the various processes for splitting Langbeinite or Glaserite (potassium double salts).

Solar pond or evaporation solar ponds are widely used for the supply of energy in the production of salts from various types of brine. The ponds are widely used for the production of NaCl but were also suggested for the production of other salts. Such ponds are widely used as evaporation ponds in the Dead Sea for the production of potash or the production of salts from salt lake brines. Such ponds serve as evaporation ponds and not for the production of other types of energy.

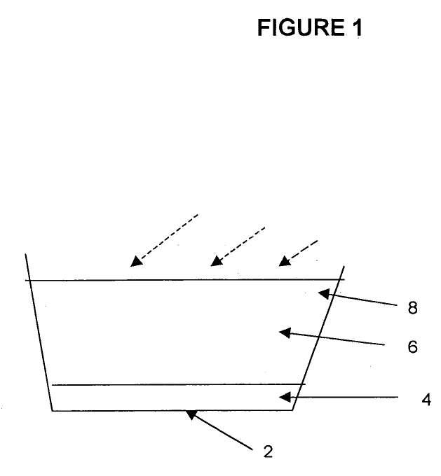

The term “solar ponds” is widely used for ponds containing stratified salt layers meant to prevent convection and were suggested as a means for producing heat, as well as for the production of electricity. The main difficulties in applying the technology results from the fact that the layered pond is thermodynamically unstable. Diffusion of salts from the concentrated layers in the bottom to the higher level, less concentrated layers, lowers the free energy of the system (AG). The diffusion as well as mixing, induced by waves and other destructive forces, tends to overturn the layered configuration and violate the stability of the pond. Various maintenance procedures were developed in which a salt or salt solution was added to the bottom zone of the pond and removed from the upper layers. (FIG. 1).

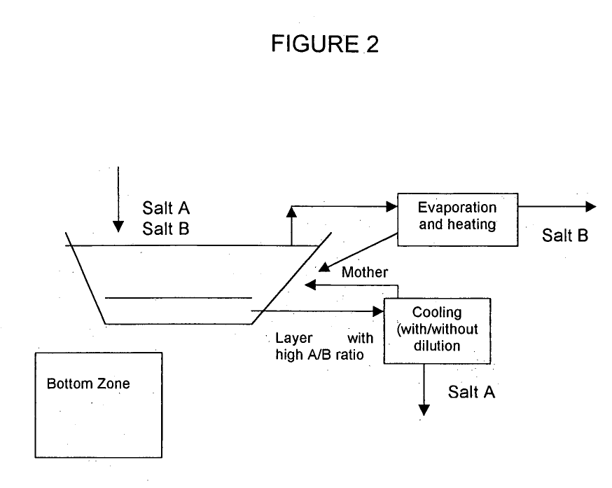

Many methods were suggested to stabilize the solar ponds. Among those methods “saturated solar ponds” was suggested as a method in which the diffusion of the salts to the upper layers of the pond is countered by the precipitation of those salts to the bottom of the pond and their dissolution there. The presence of a solute cycle is based on the fact the bottom zone is warmer than the upper layers and as such can sustain a higher salt concentration. The upper layers are colder and contain lower salt concentration. The pond needs a special type of salt for its operation. The main difficulties in applying this method involves the high cost of the salts needed for such a pond (see FIG. 2).

Solar ponds and saturated solar ponds have been suggested as a means for the accumulation of energy in the form of heat in the bottom layers of the pond.

The present invention provides A process for the separation and recovery of at least one selected salt from a mixture of salts containing at least one salt, the solubility of which increases with increase in temperature, comprising:
a) providing a pond having a dark bottom surface and a plurality of stratified salt solution layers wherein the solution closest to the bottom contains a salt concentration higher than that in the upper layers, the solution closest to the bottom is hotter than those in the upper layers and at least some of the layers are saturated with at least one salt;
b) introducing a feed solution containing at least one salt, the solubility of which increases with increase in temperature into said pond thereby resulting in an increased ratio of said at least one salt in said bottom layer;
c) withdrawing a solution from said bottom layer; and
d) withdrawing a solution from the upper layer.

The solutions obtained from steps c) and d) may be used directly or may be fed to a system for the production of the needed salts.

In preferred embodiments of the present invention the salts in said feed solution diffuse into the layers of said pond and a salt having a solubility which increases with temperature crystallizes in the upper layers, precipitates to the bottom and re-dissolves.

In especially preferred embodiments of the present invention the layer withdrawn from the bottom zone is cooled, whereby said at least one salt, the solubility of which increases with increase in temperature, crystallizes out therefrom.

In preferred embodiments of the present invention, said process is used for the recovery of specific selected salts selected from the group consisting of a carnallitic salt, KCl, MgCl₂, MgSO₄, NaCl, an SO₄ salt, a phosphate salt, a carbonate salt, a bicarbonate salt, and a borate salt.

In some preferred embodiments of the present invention, the feed solution contains a previously crystallized salt requiring recrystallization.

In other preferred embodiments of the present invention the feed solution contains a previously crystallized salt requiring to be split into a pair of pure salts.

In preferred embodiments of the present invention, a saturated solar pond is built from solutions withdrawn according to steps c and d of claim 1.

In yet further preferred embodiments of the present invention, a product stream is obtained by removing a solution from the upper layer of said pond, and crystallizing the salt or mixture of salts contained therein by heating and evaporation of water.

In said further preferred embodiments, solar energy is preferably used as an aid for evaporation and heating.

As a further benefit energy can also be a product of the pond.

Thus, an advantage of the present invention is that the process can be carried out in a manner such that the energy needed for the process is solar energy.

In further preferred embodiments of the present invention, the energy needed for the process is transferred from layers withdrawn from the pond to another by means of heat exchangers.

In accordance with the present invention it has been found that a mixture of salts containing at least one salt, the solubility of which increases with increase in temperature, may be split into layers with different salt ratios than that present in the feed solution. It was also found that the bottom hot layers, present in the bottom of the pond are enriched with those solutes the solubility of which is more dependent on temperature and the upper surface layers are enriched with those solutes the solubility of which is less dependent on temperature.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Figures:

FIG. 1 is a schematic illustration of a solar pond; and

FIG. 2 is a schematic illustration including a flow stream of the use of a saturated solar pond for splitting a mixture of salts.

Referring to FIG. 1 there is seen a schematic representation of a standard solar pond having a dark bottom 2, a concentrated salt solution in the layer 4 adjacent the bottom of the pond, intermediate layers 6 with decreasing salt concentration and upper layer 8 with dilute salt solution. In the normal operation of such a solar pond, solar radiation reaching the bottom 2 is adsorbed. The heat is transferred to the lower layer 4. Convection is avoided by ensuring a density gradient so that the density is decreased as the layer is higher.

As is known, at least part of the layers contain salt in saturation. In such a pond, the diffusion of salts to the upper layer 8 is balanced by crystallization of the salt, falling of the product crystals and their dissolution in the bottom layer 4.

For purposes of non-limiting illustration only, the mechanism of the process is illustrated in FIG. 2. This schematic illustration describes a case in which only two salts are present in solution. The same is true for a mixture of more than 2 salts.

A mixture of salts A and B enter the solar pond 2. A is a salt the solubility of which increases with increase in temperature while B is not dependent or is less dependent on temperature. The pond solution is layered in a way such as the salts concentration reduces with the distance from the bottom. The salts diffuse from the lower to the higher layer. As a result of evaporation and diffusion, the salts crystallize and the crystals dissolve until the layers become saturated. Since the solubility of A increases with the increase in temperature and since the bottom temperature is higher then in the upper layer, the A/B concentration ratio increases in the layer(s) close to the bottom. In the upper layer(s), the maximal concentration of salts A and B is their saturation concentration. Since the solubility of A at the low temperature, present in the upper layer is much lower than that at the higher temperatures present in the bottom layer, the concentration of A at the surface layer is lower than that in the lower layers thus the A/B ratio in the upper layer(s) is lower than that in the bottom layer(s).

The layers close to the bottom of the pond are withdrawn and are used as a source for component A.

The layers close to the surface of the pond are withdrawn and are used as a source for component B.

The product streams, i.e. the solution withdrawn from the bottom layer(s) and the solution withdrawn from the upper layer(s) can be used for the production of the desired salt or as a feed to another production unit. For example, the layer close to the bottom is preferably withdrawn and cooled. As a result, A crystallizes while B remains in solution. The solution withdrawn from the upper layer(s) is heated and evaporated. As a result B crystallizes.

In preferred embodiments of the present invention, the heating is induced by transferring heat from the bottom layer to the upper layer. The mother liquors from the crystallization stages can be returned to the solar pond or transferred from one crystallization unit to another crystallization unit.

The pond also produces energy, in addition to producing the product streams enriched with salts. The energy produced in the pond is preferably used for the production of electricity, for heating or for re-crystallization of the salts. The salt used in the pond are the product of the pond and therefore the salts do not contribute to the cost of the pond which was the major reason for the high cost of prior art solar ponds. As a result, salts with high solubility, that were screened out as candidates for saturated solar ponds due to the high concentration and large amount of salt needed to reach saturation, may be used and separated according to the present invention.

The synergistic benefit of the proposed process is very significant. The process supplies a source of valuable salts needed for the maintenance of the saturated solar ponds, thus eliminating the main reason preventing their commercial use, while the ponds used in the process of the present invention act as a means for the separation of a mixture of salts, a separation which does not require any additional energy, and instead only requires the energy already used by the pond for maintaining its structure. As a result the proposed invention provides both for the reduction of the production costs of salts and for reduction of the cost of energy produced by those ponds.

Table 1 present a partial list of salts and their solubility (in gr solute/kg solution) at various temperature (Frier R. K. Aqueous Solutions, volume 1, Walter de Guyter, Berlin, New York (1955).

TABLE 1

| Salt/temperature (° C.) | 20° C. | 40° C. | 60° C. | 80° C. | 100° C. |
|---|---|---|---|---|---|
| (NH₄)₂B₄O₇.4H₂O | 76.3 | 157.7 | 294.3 | 411.7 | 526.8 |
| (NH₄)B₅O₈.4H₂O | 65 | 105 | 182 | 244 | 303 |
| NH₄HCO₃ | 176 | 260 | 370 | 520 | 780 |
| NH₄Cl | 270 | 320 | 350 | 400 | 440 |
| NH₄F | 450 | 480 | 530 | 590 | |
| NH₄HF₂ | 288 | 490 | 618 | 742 | |
| NH₄NO₃ | 655 | 745 | 805 | 862 | 910 |
| NH₄H₂PO₄ | 272 | 362 | 456+ | 548 | 635 |
| (NH₄)₂HPO₄ | 408 | 450 | 492 | 540 | 590 |
| (NH₄)₂SO₄ | 430 | 450 | 467 | 485 | 505 |
| KB₅O₈.4H₂O | 30 | 52 | 90 | 147 | 223 |
| K₂CO₃ | 525 | 540 | 560 | 580 | 610 |
| KHCO₃ | 250 | 310 | 375 | | |
| KHC₂O₄.H₂O | | 266 | | 326 | |
| KCl | 255 | 285 | 313 | 336 | 356 |
| KF.2H₂O | 303 | 485 | 585 | 590 | 600 |
| KNO₃ | 115 | 240 | 393 | 526 | 625 |
| KHPO₄ | 125 | 182 | 250 | 330 | 410 |
| K₃PO₄ | 440 | 497 | 578 | 640 | |
| K₂SO₄ | 100 | 127 | 152 | 175 | 194 |
| Na₂B₄O₇ | 25 | 60 | 150 | 200 | 283 |
| Na₂CO₃.7H₂O | 179 | 328 | 315 | 306 | 306 |
| NaHCO₃ | 86 | 112 | 137 | 154 | 192 |
| NaCl | 265 | 268 | 270 | 275 | 280 |
| NaF | 40.3 | 40.6 | 42.2 | 44.9 | |
| NaNO₃ | 464 | 510 | 555 | 596 | 635 |
| Na₃PO₄.12H₂O | 101 | 180 | 282 | 369 | 434 |
| NaHPO₄ | 460 | 580 | 657 | 680 | 710 |
| NaHPO₄.7H₂O | 71 | 350 | 445 | 480 | 510 |
| Na₂SO₄.10H₂O | 162 | 332 | 325 | 318 | 298 |
| Na₂SiO₃.9H₂O | 157 | 302 | 482 | 518 | |
| AlCl₃ | 316 | 320 | 322 | 325 | 330 |
| Al(NO₃).9H₂O | 419 | 456 | 500 | 594 | 613 |
| Al₂(SO₄)₃.18H₂O | 354 | 415 | 479 | 549 | 619 |
| CaCl₂.6H₂O | 425 | 560 | 580 | 594 | 611 |
| Ca(NO₃)₂.4H₂O | 559+ | 652 | 750 | 783 | 786 |
| MgCl₂ | 352 | 365 | 380 | 400 | 420 |
| Mg(NO₃)₂.2H₂O | 415 | 445 | 480 | 520 | 722 |
| Mg(SO₄)₂.7H₂O | 258 | 306 | 352.4 | 359 | 329 |

The solubility ratio was calculated as the ratio between the solubility of a salt at 80° C. to that at 20° C.

The solubility ratio of the salts present in Table 1 is presented in Table 2

TABLE 2

| | Solubility ratio |
|---|---|
| Salt | (80° C./20° C.) |
| (NH₄)₂B₄O₇.4H₂O | 5.4 |
| (NH₄)B₅O₈.4H₂O | 3.8 |
| NH₄HCO₃ | 3.0 |
| NH₄Cl | 1.5 |
| NH₄F | 1.3 |
| NH₄HF₂ | 2.6 |
| NH₄NO₃ | 1.3 |
| NH₄H₂PO₄ | 2.0 |
| (NH₄)₂HPO₄ | 1.3 |
| (NH₄)₂SO₄ | 1.1 |
| KB₅O₈.4H₂O | 4.9 |
| K₂CO₃ | 1.1 |
| KHCO₃ | 1.6 |
| KHC₂O₄.H₂O | 1.2 |
| KCl | 1.3 |
| KF.2H₂O | 1.9 |
| KNO₃ | 4.6 |
| KHPO₄ | 2.6 |
| K₃PO₄ | 1.5 |
| K₂SO₄ | 1.8 |
| Na₂B₄O₇ | 8.0 |
| Na₂CO₃.7H₂O | 1.7 |
| NaHCO₃ | 1.8 |
| NaCl | 1.04 |
| NaF | 1.1 |
| NaNO₃ | 1.3 |
| Na₃PO₄.12H₂O | 3.7 |
| NaHPO₄ | 1.5 |
| NaHPO₄.7H₂O | 6.8 |
| Na₂SO₄.10H₂O | 2.0 |
| Na₂SiO₃.9H₂O | 3.3 |
| AlCl₃ | 1.0 |
| Al(NO₃).9H₂O | 1.4 |
| Al₂(SO₄)₃.18H₂O | 1.6 |
| CaCl₂.6H₂O | 1.4 |
| Ca(NO₃)₂.4H₂O | 1.4 |
| MgCl₂ | 1.1 |
| Mg(NO₃)₂.2H₂O | 1.3 |
| Mg(SO₄)₂.7H₂O | 1.4 |

The enrichment ratio of a mixture of 2 salts was calculated by dividing the solubility ratio of one salt by that of the other. The enrichment ratio is the first approximation of the expected enrichment ratio (and does not take into account the effect of one salt on the solubility of the other). The results are presented in Table 3 and Table 4.

TABLE 3
The expected enrichment ratio of salt mixtures

| | Expected enrichment |
|---|---|
| Salt mixture | ratio |
| K₂B₅O₈/KCl | 3.72 |
| KNO₃/KCl | 3.47 |
| NaHPO₄/Na₂SO₄ | 3.44 |
| MgSO4/NaCl | 1.34 |
| KCl/NaCl | 1.27 |
| MgCl₂/NaCl | 1.10 |

TABLE 4
The enrichment ratio of minerals and of NaCl/minerals mixture

| | | Enrichment |
|---|---|---|
| Minerals | Salts | ratio |
| NaCl/Kainite | KCl/NaCl | 1.27 |
| NaCl/Kainite | MgSO₄/NaCl | 1.34 |
| NaCl/Schoenite | K2SO₄/NaCl | 1.69 |
| NaCl/Carnelite | MgCl₂/NaCl | 1.10 |
| Kainite | MgSO₄/KCl | 1.06 |

The following examples and tables will further demonstrate the efficiency of the process of the present invention. The behavior of complex salt mixtures is much more complicated than expected by the enrichment ratio. In the case of the salt mixture KCl, MgCl₂, NaCl, it was found that the enrichment ratio was much higher.

### EXAMPLE 1

220 tons of KCl is mixed with 200 tons of NaCl and 1000 tons of water.

100 tons of the solution is introduced to a pond with a dark bottom 100 tons of the above solution is mixed with 25 tons of water and introduced gently to the surface of the pond. The same procedure is repeated with solutions containing 50 tons of water, 75 tons of water, 100 tons of water, 125 tons of water, 150 tons of water, 175 tons of water, 200 tons of water, 225 tons of water, 250 tons of water, 275 tons of water and 300 tons of water.

The pond is left to be heated by solar energy for a period of 1 month, during which the temperature in the bottom layer reaches 60° C.

After one month, a solution with the above composition is introduced slowly and continuously to a layer present 50 cm above the bottom of the pond. Samples from the brine from the upper layer and the brine from the bottom layer are removed and analyzed. The KCl/NaCl ratio in the upper layer is found to be (1) while that in the bottom layer is found to be lower than 1.2.

The pond is left to be heated by solar energy for an additional 1 month period, during which the temperature in the bottom layer reaches 80° C. The bottom layer is removed continuously and has a KCl/NaCl ratio of 1.3, while the upper surface layer that is also continuously removed has a KCl/NaCl ratio of 0.95.

After 3 months, the temperature of the bottom layer reaches 90 C, while the KCl/NaCl ratio in this layer is 1.4.

### EXAMPLE 2

100 tons of carnallite and 500 tons of water are mixed and added slowly and continuously to the surface of the pond described in Example 1 during a period of 2 months and the bottom layer is continuously removed. The bottom layer temperature after 3 months is about 90° C. while the lower layer contains mainly KCl and NaCl at about 2/1 molar ratio and the upper layer contains mainly MgCl₂ with a MgCl₂/KCl molar ratio of about 10 and a MgCl₂/NaCl molar ratio of about 15.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A process for the separation and recovery of at least one selected salt from a mixture of salts containing at least one salt, the solubility of which increases with increase in temperature, comprising:
a) providing a pond having a dark bottom surface and a plurality of stratified salt solution layers wherein the solution closest to the bottom contains a salt concentration higher than that in the upper layers, the solution closest to the bottom is hotter than those in the upper layers and at least some of the layers are saturated with at least one salt;
b) introducing a feed solution containing at least one salt, the solubility of which increases with increase in temperature into said pond thereby resulting in an increased ratio of said at least one salt in said bottom layer;
c) withdrawing a solution from said bottom zone; and
d) withdrawing a solution from the upper zone.

2. A process for the separation and recovery of at least one selected salt from a mixture of salts according to claim 1, wherein the layer withdrawn from the bottom zone is cooled, whereby said at least one salt, the solubility of which increases with increase in temperature, crystallizes out therefrom.

3. A process according to claim 1 wherein one of the recovered selected salts is a carnallitic salt.

4. A process according to claim 1 wherein one of the recovered selected salts is KCl.

5. A process according to claim 1 wherein one of the recovered selected salts is MgCl₂.

6. A process according to claim 1 wherein one of the recovered selected salts is MgSO₄.

7. A process according to claim 1 wherein one of the recovered selected salts is NaCl.

8. A process according to claim 1 wherein part of the recovered selected salts is an SO₄ salt.

9. A process according to claim 1 wherein one of the recovered selected salts is a phosphate salt.

10. A process according to claim 1 wherein one of the recovered selected salts is a carbonate salt.

11. A process according to claim 1 wherein one of the recovered selected salts is a bicarbonate salt.

12. A process according to claim 1 wherein one of the recovered selected salts is a borate salt.

13. A process according to claim 1 the feed solution contains a previously crystallized salt requiring recrystallization.

14. A process according to claim 1 wherein the feed solution contains a previously crystallized salt requiring to be split into a pair of pure salts.

15. A process according to claim 1 wherein a saturated solar pond is built from solutions withdrawn according to steps c and d of claim 1.

16. A process according to claim 1 wherein a product stream is obtained by removing a solution from the upper zone of said pond, and crystallizing the salt or mixture of salts contained therein by heating and evaporation of water.

17. A process according to claim 16 wherein solar energy is used as an aid for evaporation and heating.
